(19) United States
(12) Patent Application Publication
(10) Pub. No.: US 2015/0029225 A1
(43) Pub. Date: Jan. 29, 2015

(54) Technique to Reverse Automatic Screen Content Rotation

(71) Applicant: Microsoft Corporation, Redmond, WA (US)

(72) Inventor: Ronald Aigner, Redmond, WA (US)

(73) Assignee: Microsoft Corporation, Redmond, WA (US)

(21) Appl. No.: 13/953,589

(22) Filed: Jul. 29, 2013

(51) Int. Cl. G09G 5/38; G06F 3/01

(52) U.S. Cl. CPC G09G 5/38; G06F 3/017
USPC 345/650

(57) ABSTRACT

Often when a user rotates a mobile computing device such as a smart phone, a tablet computer or other multifunction computing device, the orientation of the information displayed on the screen of the device is also rotated. In the technique described herein, the user can reverse the orientation of screen content with a simple action, such as a gesture. In one embodiment, once rotation of the screen of a mobile computing device is detected a hint can be displayed to a user using the mobile device to revert screen content rotation using some type of an action. The user then performs the action/gesture and the user's action or gesture is detected. The screen content rotation is then reversed based on the detected user action. Once the rotation is reversed the orientation of the content can be locked.

### BACKGROUND

Tablet computers, smart-phones or other similar portable or mobile multifunction computing devices with equipment to detect device rotation automatically allow rotation of the information displayed on the screen of the device when the device is rotated. For example, the content displayed on the display of such a device will be rotated when the device is changed from a landscape orientation to a portrait orientation. Often when the device is rotated, especially when it is lying on a flat surface, the person using the device does not want the information or content displayed on the display to be rotated as well. There are mechanisms to prevent the screen rotation before it happens. On devices where these mechanisms do not exist or are not active, the rotation happens whether the user desires that the screen content be rotated or not.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, the automatic screen content rotation reversion technique described herein detects the rotation of a tablet computer, smart phone or other similar multifunction mobile computing device, and allows a user to reverse the corresponding rotation of content displayed on the display of the device using a simple action. For example, this action might be a gesture by the user of the device consisting of concurrent swiping motions in opposite directions and on opposite sides of the screen of the device to reverse the screen content rotation. In this embodiment, the screen content orientation changes in the direction given by the motions. This gesture, in one embodiment, is at the sides of the screen, which are reachable by a user holding the device with his hands on both sides. Once the content rotation is reversed the technique can lock the orientation of the content.

In one embodiment of the technique, once rotation of the screen (e.g., of a computing device or of a mobile computing device) is detected a hint is displayed to a user using the computing device to revert screen content rotation using some type of an action, such as, for example, a gesture. For example, this hint can be an animation on the edges of the screen suggesting that the user simultaneously swipe the edges of the display in opposite directions. Or a prompt can be displayed to the user to touch the display (e.g., a touch display) of the device in a certain place in order to reverse the screen rotation. Many other types of similar hints or prompts are possible. The user then performs the action described in the hint and the user's action or gesture is detected. The technique then takes action to reverse the screen content rotation. Once the content rotation is reversed the technique can lock the orientation of the content on the screen or display of the device.

### DESCRIPTION OF THE DRAWINGS

The specific features, aspects, and advantages of the disclosure will become better understood with regard to the following description, appended claims, and accompanying drawings where:

FIG. 1 depicts a diagram of a user holding a mobile computing device such as, for example, a smart phone, a tablet computer or similar multifunction computing device before device rotation. The device is being held by a user in a landscape orientation.

FIG. 2 depicts a diagram of one exemplary embodiment of the automatic screen content rotation reversion technique described herein that shows the user holding the mobile computing device shown in FIG. 1 after device rotation. The device has been rotated to a portrait orientation. Gesture hints in the form of opposing arrows on opposing sides of the screen (which can be animated) can be shown on the display of the device to prompt the user to reverse the rotation of the content of the device by swiping in the direction of the arrows if the rotation of the content on the screen is undesired.

FIG. 3 depicts a diagram of a user holding the device shown in FIG. 1 after device rotation. The device has been rotated to a portrait orientation. A notification to reverse the screen content rotation is displayed on the display of the device to prompt the user to reverse the rotation of the content if the rotation of the content on the screen is undesired.

FIG. 4 depicts a flow diagram of one embodiment of a process for employing the automatic screen content rotation reversion technique.

FIG. 5 depicts a flow diagram of another embodiment of a process for employing the automatic screen content rotation reversion technique.

FIG. 6 depicts an exemplary architecture for practicing one embodiment of the automatic screen content rotation reversion technique.

FIG. 7 is a schematic of an exemplary computing environment which can be used to practice the automatic screen content rotation reversion technique.

### DETAILED DESCRIPTION

In the following description of the automatic screen content rotation reversion technique, reference is made to the accompanying drawings, which form a part thereof, and which show by way of illustration examples by which the automatic screen content rotation reversion technique described herein may be practiced. It is to be understood that other embodiments may be utilized and structural changes may be made without departing from the scope of the claimed subject matter.

### 1.0 Automatic Screen Content Rotation Reversion Technique

The following sections provide an introduction, an overview of the automatic screen content rotation reversion technique, as well as a description of various exemplary embodiments.

1.1 Introduction

The automatic screen content rotation reversion technique makes it easier for users of mobile computing devices which support screen automatic screen content rotation, to reverse accidental or unwanted automatic screen content rotation. It reduces frustration for the user of a mobile device. The automatic screen content rotation reversion technique can also be used to reverse the rotation of content on the screen (display/monitor) of a desk top computer if a user turns the screen from a horizontal orientation to a vertical orientation and vise-versa and the display or monitor is equipped to sense this rotation of the screen.

1.2 Overview of the Technique

In general, the automatic screen content rotation reversion technique detects screen rotation, such as the screen of a mobile computing device rotation. The technique can display hints to reverse screen content rotation and can take action to reverse screen content rotation with or without displaying a hint.

1.2.1 Detecting Device Rotation

There are many known ways to detect mobile computing device rotation and associated screen content rotation. There are various ways device rotation is detected and these are used in various embodiments of the technique. Some embodiments of the automatic screen content rotation reversion technique detect device rotation using the input of a two-axis accelerometer. Other embodiments of the technique detect screen rotation using the input of mercury switches which provide an indication of the orientation of the device. Another known method of detecting the rotation of a device is by using a gyroscope embedded in the device. Many mobile computing devices are already equipped with such accelerometers, mercury switches and gyroscopes.

1.2.2 Displaying Hints to Reverse Screen Rotation

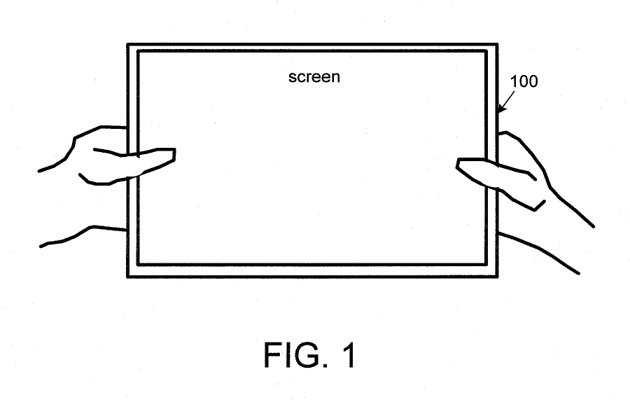

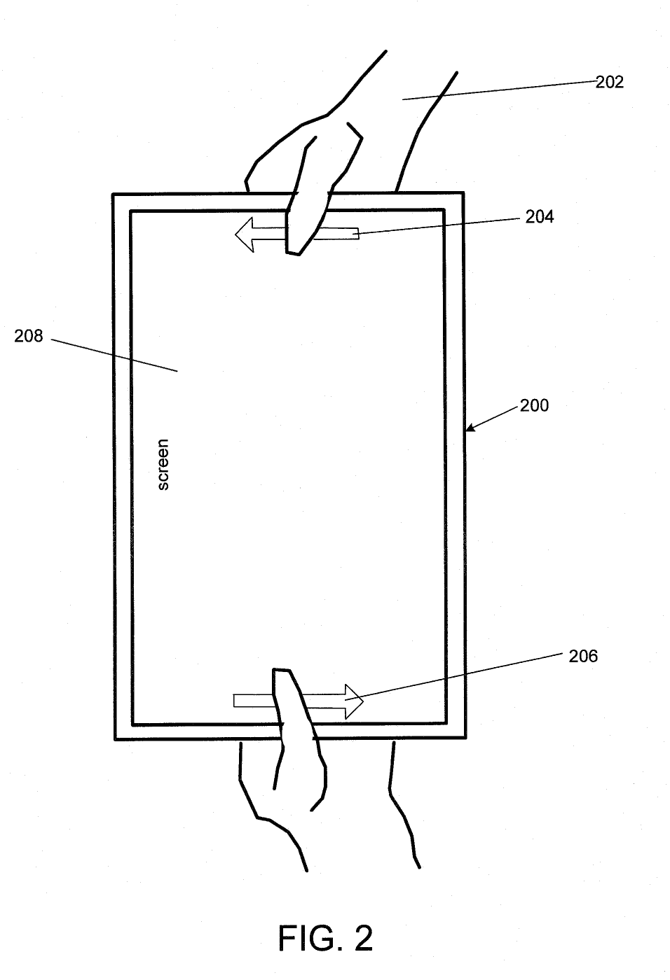

When device rotation is detected, in one embodiment the device can start rotating the content on the display or even complete the content rotation via conventional methods, and then display a hint or a prompt to a user using the device on how to reverse the screen content rotation. For example, the hint can be an animation of arrows at the side of the screen. For example, FIG. 2 depicts a diagram of one exemplary embodiment of the automatic screen content rotation reversion technique that shows a user 202 holding mobile computing device 200 (which is the same mobile computing device 100 shown in FIG. 1) after device rotation. The device 200 has been rotated to a portrait orientation. Gesture hints in the form of opposing arrows 204, 206 (which can be animated) on opposing sides of the display 208 are shown to prompt the user 202 to reverse the rotation of the content of the device if the rotation of the content on the screen is undesired. The hint/animation arrows 204, 206 show the user 202 to swipe along the edges of the screen 208 in opposing directions. The region for the swipe is easily reachable by the user 202 holding the device 200.

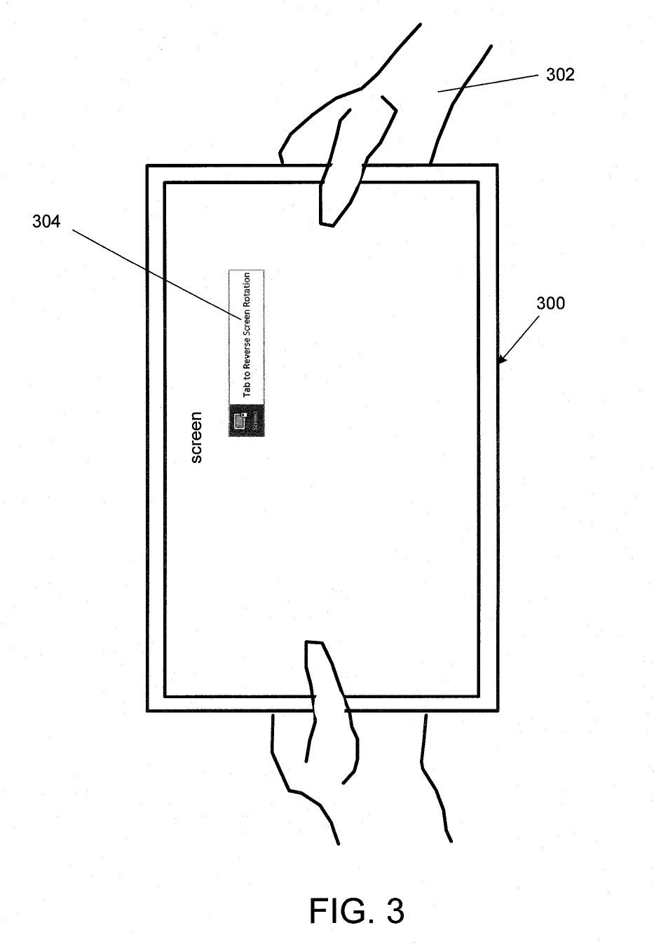

As an alternative, in another embodiment, the screen can display a notification such as, for example, “To revert the screen rotation, press here”, which is easily accessible by the user. FIG. 3 depicts an exemplary schematic of a user 302 holding the device 300 shown in FIG. 1 after device rotation. A notification 304 to reverse the screen content rotation is displayed on the display of the device to prompt the user 302 to reverse the rotation of the content of the device 300 if the rotation of the content on the screen 306 is undesired. The user can then touch an area on the screen of the device if the device has a touch screen in order to respond to the notification. It should be noted, however, that the notification shown in FIG. 3 can be shown on devices with or without touch screen capabilities. The notification can then be selected (e.g., clicked), for instance by a mouse or other input device. Or the notification can identify a button to press to reverse the screen content rotation. The text in these notifications could then read, for example, “Click here to reverse screen rotation” or “Press the ‘Home’ button to reverse screen orientation”, respectively. Any suitable notification to reverse the screen rotation can be used to notify the user, and various types of input can be used to respond to the notification based on the input capabilities of the device.

1.2.3 Action to Reverse Screen Rotation

When the user initiates an action to activate the reversal of the screen content rotation, for example by either swiping along the edges of the screen according to the displayed animation or by tabbing the notification, the device reverses the screen content rotation and can automatically lock the screen content rotation. The screen content orientation can be locked until the next screen rotation is detected. For example, if the user rotates the device back to landscape mode, the lock can be removed (automatically). As an alternative, the current content may be locked as long as the content is active (for example, an e-book app may keep the screen orientation lock active as long as the user reads). Or, in another embodiment of the technique, screen content may be locked continuously until the user chooses to revoke the screen orientation lock via a settings dialog.

A general overview of the automatic screen content rotation reversion technique having been provided, the following section provides a description of exemplary embodiments of the automatic screen content rotation reversion technique.

1.4 Exemplary Processes for Automatic Screen Rotation Reversion

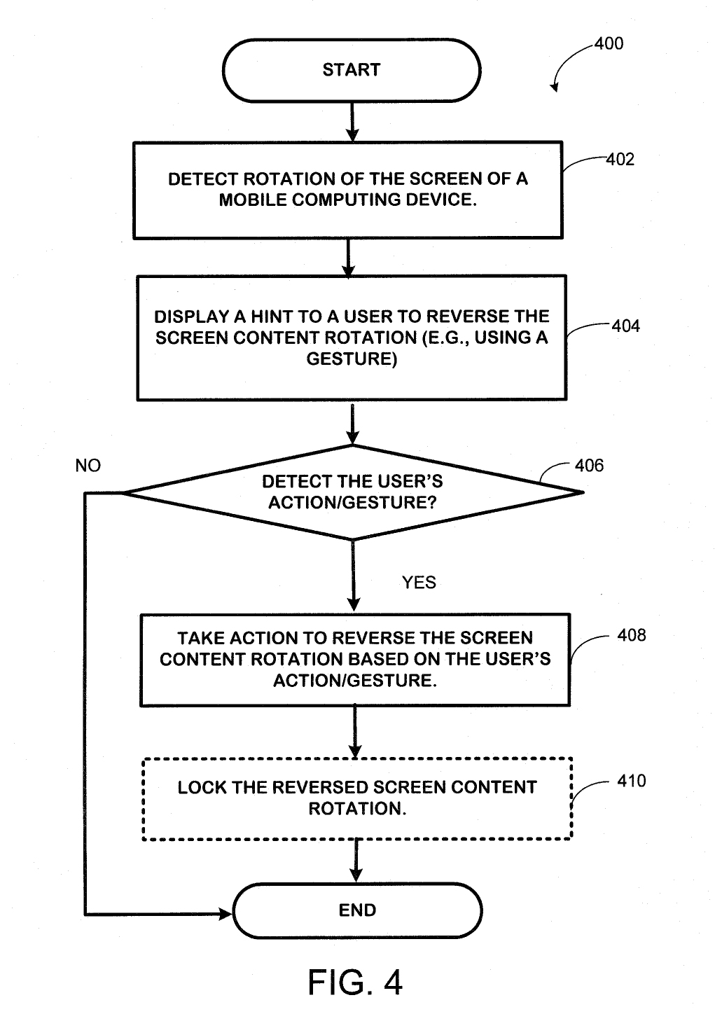

FIG. 4 shows an exemplary process 400 for automatic screen rotation reversion according the automatic screen rotation technique. As shown in block 402, the automatic screen content rotation reversion technique detects screen rotation (and associated screen content rotation). As discussed previously, this can be done in one of many known ways. For example, one or more accelerometers, mercury switches or a gyroscope on the screen/display or on a mobile computing device with the screen installed in it can detect the screen rotation.

The automatic screen rotation mechanism can then display a hint to reverse the screen content rotation, as shown in block 404. For example, action or gesture hints can be shown on the display of the device. One type of gesture hint can be an animation of parallel arrows 204, 206 pointed in opposite directions on opposing sides of the screen 208, as shown in FIG. 2. With this gesture hint a user can swipe the display with both hands in direction of the opposing arrows in order to reverse the screen rotation. Another type of hint that can be displayed is a notification 304 that tells a user 300 how to reverse screen content rotation (e.g., by touching the screen or the device in a certain place), as shown if FIG. 3. For this type of hint, the user can touch the screen in a predetermined place if the screen is a touch screen, or can activate a button on the device that has been purposed for the function of reverting screen rotation. Or the hint can be an audible hint spoken to the user, and the response by the user can be an audible command. Alternately, the user can take other appropriate actions to the hint in response.

The automatic screen rotation technique recognizes the user's action or gesture, as shown in block 406. For example, the technique can detect a gesture on a touch screen of the device if the device is a touch screen capable device. Or a camera on the device can detect the motion of the user's fingers or hands to determine the gesture. Similarly, the user's action can be an audible command or voice command that is captured by a microphone and is recognized by the technique as a command. Or a button on the device can be activated to reverse the screen content rotation.

Once the user's action or gesture has been detected by the automatic screen rotation technique, action is automatically taken to reverse the screen content rotation, as shown in block 406. This can also be done in one of many known ways.

If no gesture is detected with a prescribed period of time, the screen content rotation will not be reversed.

Once the screen content rotation has been reversed the rotation of the screen content can be locked, as shown in block 410. The screen content orientation can be locked until the next screen rotation is detected. For example, if the user rotates the device back, the lock can be automatically removed. As an alternative, the current content may be locked as long as the content is active. Or, in another embodiment of the technique, screen content may be locked continuously until the user chooses to revoke the screen orientation lock via a settings dialog.

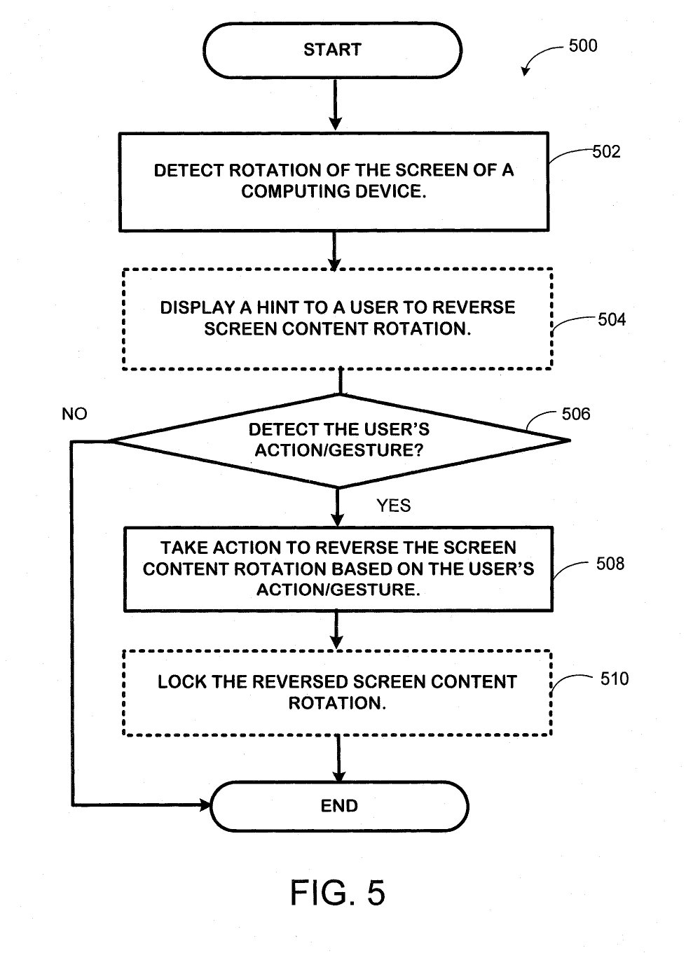

FIG. 5 shows another exemplary process 500 for automatic screen rotation reversion according the automatic screen rotation technique. As shown in block 502, the automatic screen content rotation reversion technique detects device or screen rotation. For example, one or more accelerometers, mercury switches or a gyroscope on the screen/display or on a mobile computing device with the screen installed in it can detect the screen rotation, as discussed previously.

The automatic screen rotation technique can then optionally display a hint to reverse the screen rotation, as shown in block 504. For example, a notification to reverse the screen rotation can be displayed (as previously discussed with respect to FIG. 3). For this type of gesture hint, the user can touch the screen in a predetermined place if the screen is a touch screen, or can activate a button on the device that has been purposed for the function of reverting screen content rotation. Or as discussed previously, one type of hint can be an animation of parallel arrows pointed in opposite directions on opposing sides of the screen, as shown in FIG. 2. Or the hint can be an audible hint spoken to the user, and the response by the user can be an audible command. Those with ordinary skill in the art will realize the many other types of hints and prompts can be used to prompt a user to reverse the screen content rotation. It should be noted that the displaying of a hint in this embodiment of the technique is entirely optional.

The user can take an action to indicate reversal of the rotation of screen content once the device or screen rotation has taken place, either with or without a hint being displayed, as shown in block 506. For example, a user can swipe the edges of the display with both hands opposing directions in order to reverse the screen rotation for a device that is equipped with a touch screen or that has a camera to detect user gestures. Or the user can issue an audible command to reverse screen rotation. Likewise, the user can activate a button on the device purposed to reverse screen content rotation. Those with ordinary skill in the art will realize the many other types of gestures and actions can be used to by a user to activate the reversal of the screen content rotation.

Once the user's action indicating a desire to reverse the screen rotation has been detected by the device, the automatic screen rotation technique can take action to reverse the screen content rotation, as shown in block 508. This can also be done in one of many conventional ways.

If no gesture is detected with a prescribed period of time after the device rotation is detected, the screen content rotation will not be reversed.

Once the screen content rotation has been reversed the rotation of the screen content can be locked, as shown in block 510. As discussed with respect to previous embodiments, the screen content orientation can be locked until the next screen rotation is detected. Or the current content's orientation may be locked as long as the content is active. Or, in another embodiment of the technique, screen content may be locked continuously until the user chooses to revoke the screen orientation lock via a settings dialog.

1.5 Exemplary Architecture for Automatic Screen Rotation Reversion

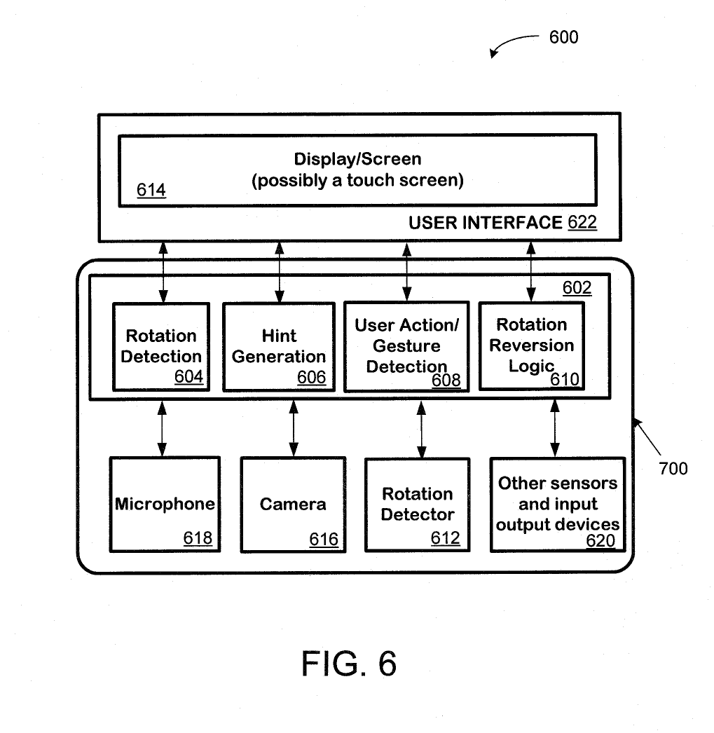

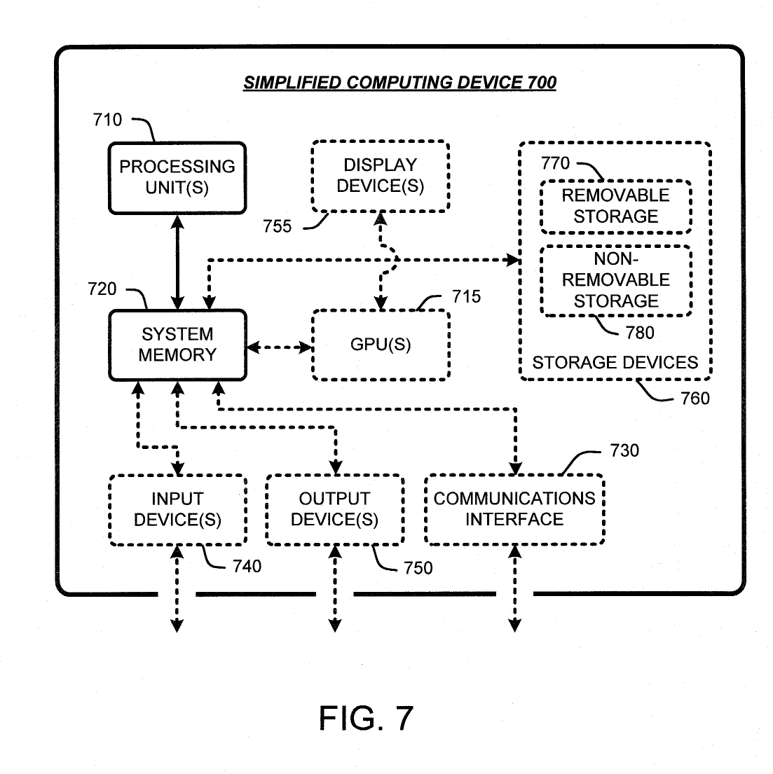

FIG. 6 shows an exemplary architecture 600 for practicing automatic screen content rotation reversion according to one embodiment of the automatic screen content rotation reversion technique. The architecture of this embodiment employs a mobile computing device 700, such as will be described in greater detail with respect to FIG. 7.

As shown in FIG. 6, the mobile computing device 700 employs an automatic screen rotation reversion module 602. This automatic screen rotation reversion module 602 contains a screen rotation detection module 604 to detect device or screen rotations, as well as a hint generation module 606 that can generate hints or prompts to a user to reverse the screen content rotation. A user action/gesture detection module 608 detects user actions and/or gestures. A rotation reversion logic module 610 provides the logic to determine when and how to reverse the screen content rotation.

The mobile computing device 700 also includes one or more rotation detectors 612 that provide detection of mobile computing device rotation and/or rotation of the screen 614. These can be a two-axis linear accelerometer, one or more mercury switches or a gyroscope, for example. Another sensor that can be employed on the mobile computing device is a touch sensor on the screen 614 of the mobile computing device 700 that senses physical contact when a user touches the screen or is very near to touching the screen, or that senses the input of a stylus or pen for interactive displays (such as tablets with stylus support). Yet another sensor that can be included on the mobile computing device is an image sensor 616 such as a camera that can detect or track a user's hand motions relative to the device. Similarly, a microphone 618 can be included on the mobile computing device 700.

The sensors that are employed on the mobile computing device are not limited to the sensors shown in FIG. 6. Many other types of sensors 620 that are typically used on mobile computing devices can also be employed to provide device rotation detection, hint generation, user action/gesture detection and screen content rotation reversal.

Most user actions and gestures displayed to the user and received from the user are implemented through a user interface 622.

### 2.0 Exemplary Operating Environments

The automatic screen content rotation reversion technique described herein is operational within numerous types of general purpose or special purpose computing system environments or configurations. FIG. 7 illustrates a simplified example of a general-purpose computer system on which various embodiments and elements of the automatic screen content rotation reversion technique, as described herein, may be implemented. It should be noted that any boxes that are represented by broken or dashed lines in FIG. 7 represent alternate embodiments of the simplified computing device, and that any or all of these alternate embodiments, as described below, may be used in combination with other alternate embodiments that are described throughout this document.

For example, FIG. 7 shows a general system diagram showing a simplified computing device 700. Such computing devices can be typically be found in devices having at least some minimum computational capability, including, but not limited to, personal computers, server computers, hand-held computing devices, laptop or mobile computers, communications devices such as cell phones and PDA's, multiprocessor systems, microprocessor- based systems, set top boxes, programmable consumer electronics, network PCs, minicomputers, mainframe computers, audio or video media players, etc.

To allow a device to implement the automatic screen content rotation reversion technique, the device should have a sufficient computational capability and system memory to enable basic computational operations. In particular, as illustrated by FIG. 7, the computational capability is generally illustrated by one or more processing unit(s) 710, and may also include one or more GPUs 715, either or both in communication with system memory 720. Note that that the processing unit(s) 710 of the general computing device may be specialized microprocessors, such as a DSP, a VLIW, or other micro-controller, or can be conventional CPUs having one or more processing cores, including specialized GPU-based cores in a multi-core CPU. When used in special purpose devices such as the automatic screen content rotation reversion technique, the computing device can be implemented as an ASIC or FPGA, for example.

In addition, the simplified computing device of FIG. 7 may also include other components, such as, for example, a communications interface 730. The simplified computing device of FIG. 7 may also include one or more conventional computer input devices 740 (e.g., pointing devices, keyboards, audio and speech input devices, video input devices, haptic input devices, devices for receiving wired or wireless data transmissions, etc.). The simplified computing device of FIG. 7 may also include other optional components, such as, for example, one or more conventional computer output devices 750 (e.g., display device(s) 755, audio output devices, video output devices, devices for transmitting wired or wireless data transmissions, etc.). Note that typical communications interfaces 730, input devices 740, output devices 750, and storage devices 760 for general-purpose computers are well known to those skilled in the art, and will not be described in detail herein.

The simplified computing device of FIG. 7 may also include a variety of computer readable media. Computer readable media can be any available media that can be accessed by computer 700 via storage devices 760 and includes both volatile and nonvolatile media that is either removable 770 and/or non-removable 780, for storage of information such as computer-readable or computer-executable instructions, data structures, program modules, or other data. Computer readable media may comprise computer storage media and communication media. Computer storage media refers to tangible computer or machine readable media or storage devices such as DVD's, CD's, floppy disks, tape drives, hard drives, optical drives, solid state memory devices, RAM, ROM, EEPROM, flash memory or other memory technology, magnetic cassettes, magnetic tapes, magnetic disk storage, or other magnetic storage devices, or any other device which can be used to store the desired information and which can be accessed by one or more computing devices.

Storage of information such as computer-readable or computer-executable instructions, data structures, program modules, etc., can also be accomplished by using any of a variety of the aforementioned communication media to encode one or more modulated data signals or carrier waves, or other transport mechanisms or communications protocols, and includes any wired or wireless information delivery mechanism. Note that the terms “modulated data signal” or “carrier wave” generally refer to a signal that has one or more of its characteristics set or changed in such a manner as to encode information in the signal. For example, communication media includes wired media such as a wired network or direct-wired connection carrying one or more modulated data signals, and wireless media such as acoustic, RF, infrared, laser, and other wireless media for transmitting and/or receiving one or more modulated data signals or carrier waves. Combinations of any of the above should also be included within the scope of communication media.

Further, software, programs, and/or computer program products embodying some or all of the various embodiments of the automatic screen content rotation reversion technique described herein, or portions thereof, may be stored, received, transmitted, or read from any desired combination of computer or machine readable media or storage devices and communication media in the form of computer executable instructions or other data structures.

Finally, the automatic screen content rotation reversion technique described herein may be further described in the general context of computer-executable instructions, such as program modules, being executed by a computing device. Generally, program modules include routines, programs, objects, components, data structures, etc., that perform particular tasks or implement particular abstract data types. The embodiments described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

It should also be noted that any or all of the aforementioned alternate embodiments described herein may be used in any combination desired to form additional hybrid embodiments. Although the subject matter has been described in language specific to structural features and/or methodological acts, it is to be understood that the subject matter defined in the appended claims is not necessarily limited to the specific features or acts described above. For example, the technique to reverse automatic screen content rotation can easily be applied to free standing display screens that reverse screen content when they are rotated. The specific features and acts described above are disclosed as example forms of implementing the claims.

What is claimed is:

1. A computer-implemented process for using gesturing to reverse the rotation of content displayed on s screen of a mobile computing device, comprising:
detecting rotation of the screen of the mobile computing device;
displaying a hint to a user to reverse screen content rotation using a gesture;
detecting the user's gesture;
taking action to reverse the screen content rotation based on the user's gesture.

2. The computer-implemented process of claim 1 wherein the screen rotation is detected by an accelerometer on the mobile computing device

3. The computer-implemented process of claim 1 wherein the hint is an animation of arrows at the sides of the screen.

4. The computer-implemented process of claim 3 wherein the arrows at the side of the screen show the user to simultaneously swipe along the edges of the screen in opposing parallel directions.

5. The computer-implemented process of claim 4 wherein an area for the user to swipe along the edges of the screen in opposing directions is easily reachable by the user while holding the computing device.

6. The computer-implemented process of claim 1 wherein the hint is a notification on the screen that prompts the user to touch the screen in a certain area to reverse the screen content rotation.

7. The computer-implemented process of claim 1 wherein the user's gesture is detected by the user touching a touch screen on the mobile computing device.

8. The computer-implemented process of claim 1 further comprising:
locking the screen content rotation once the screen content rotation is reversed.

9. A computer-implemented process for using a user's action to reverse the rotation of content displayed on the screen of a computing device, comprising:
detecting rotation of the screen of the computing device;
detecting a user's action indicating the user's desire to reverse screen content rotation; and
taking action to reverse the screen content rotation based on the user's action.

10. The computer-implemented process of claim 9 wherein the screen rotation is detected by a mercury switch on the screen or the computing device.

11. The computer-implemented process of claim 9 wherein the user's action is swiping along the edges of the screen in opposite directions.

12. The computer-implemented process of claim 9 wherein the user's action is a gesture detected by a camera on the computing device.

13. The computer-implemented process of claim 9 wherein the user's action is a voice command commanding reversal of screen content rotation.

14. The computer-implemented process of claim 9 wherein the user's action is activating a button that initiates reversal of screen content rotation.

15. A system for reversing the rotation of the content displayed on a screen of a mobile computing device, comprising:
a mobile computing device;
a computer program comprising program modules executable by the computing device, wherein the computing device is directed by the program modules of the computer program to,
detect rotation of the content displayed on the screen of the mobile computing device;
provide a hint to a user to reverse the screen content rotation with a user action;
detect an action from the user; and
take action to reverse the rotation of the content of the screen based on the user's action.

16. The system of claim 15 wherein the module to detect rotation of the content of the screen detects the beginning of rotation of the content, and wherein the hint is displayed before rotation is complete.

17. The system of claim 15 wherein the module to detect rotation of the content of the screen detects the complete rotation of the content, and wherein the hint is displayed after content rotation is complete.

18. The system of claim 15 wherein the hint is an audible hint.

19. The system of claim 15 wherein the action of the user is a voice command.

20. The system of claim 15 wherein the screen is a touch screen and wherein the user's action is swiping along the edges of the screen in opposite directions.
